(19) United States
(12) Patent Application Publication
(10) Pub. No.: US 2024/0356636 A1
(43) Pub. Date: Oct. 24, 2024

(54) METHOD AND SYSTEM FOR A HEALTH AUDIT ON A CURRENT WORKING ROUTE IN LAYER ZERO CONTROL PLANE NETWORKS

(71) Applicant: CIENA CORPORATION, Hanover, MD (US)

(72) Inventors: Manish Aggarwal, New Delhi (IN); Sandeep Kumar Gupta, Gurgaon (IN); Vikas Chander, Haryana (IN)

(73) Assignee: CIENA CORPORATION, Hanover, MD (US)

(21) Appl. No.: 18/327,162

(22) Filed: Jun. 1, 2023

(30) Foreign Application Priority Data
Apr. 21, 2023 (IN) 202311029111

(51) Int. Cl. H04B 10/079

(52) U.S. Cl. CPC H04B 10/0795

(57) ABSTRACT

Aspects of the subject disclosure may include, for example, a node in a fiber optic network, the node comprising a processing system comprising a processor and executable instructions that, when executed by the processing system, facilitate performance of operations, including receiving an automatic or manual trigger; checking nodes in a current working route for a failure responsive to receiving the automatic or manual trigger; raising an alarm responsive to detecting the failure; and performing operations associated with the automatic or manual trigger responsive to not detecting the failure. Other embodiments are disclosed.

### CROSS-REFERENCE TO RELATED APPLICATIONS

This application claims priority under 35 U.S.C. § 1.119 to Indian patent application No. 202311029111, filed on Apr. 21, 2023. All sections of the aforementioned application(s) and/or patent(s) are incorporated herein by reference in their entirety.

### FIELD OF THE DISCLOSURE

The subject disclosure relates to a method and system for a health audit on a current working route in layer zero control plane (L0CP) for fiber optic networks.

### BACKGROUND

An intelligent optical control plane is software that controls all aspects of configuring connections between optical switches across a network. With sometimes hundreds of nodes across a network, managing such a complex infrastructure requires a control plane that, given some parameters, will make decisions on its own (thus the “intelligent” in intelligent control plane). L0CP supports reporting various faults, depending on the required functionality for the corresponding fault and configured service type. Optical Switching and Routing Protocol (OSRP) decides how to perform network mesh restoration. There are many such situations/issues which do not require mesh restoration, but adversely affect the required functionality, for example, there may be several reasons which may not be limited to:
Comms failure of the control path along the current working route;
Local shelf sync issues;
Node blocked, because of many reasons, e.g., an upgrade is in progress that causes the provisioning block, database backup/restore, etc.; and/or
Domain Optical Controller (DOC) out of service (DOC-OOS) on any of the nodes along the route.

In all the above cases, a channel deprovisioning request gets stuck due to an inability of local controllers to delete the cross connects (CRS) provisioned on the current path. That leads to extended traffic outages, in the case of automatic and manual path switch operations. In some cases, this further leads to a permanently stuck stale cross connect, since the above issues are not resolved, which, in turn, causes stuck bandwidth to become unusable.

### BRIEF DESCRIPTION OF THE DRAWINGS

Reference will now be made to the accompanying drawings, which are not necessarily drawn to scale, and wherein:

FIG. 1A is a block diagram illustrating an exemplary, non-limiting embodiment of a fiber optic network functioning in accordance with various aspects described herein.

FIG. 1B is a block diagram illustrating an exemplary, non-limiting embodiment of a fault in a fiber optic network functioning in accordance with various aspects described herein.

FIG. 1C is a block diagram illustrating an exemplary, non-limiting embodiment of a comms failure following fault recovery in a fiber optic network functioning in accordance with various aspects described herein.

FIG. 1D is a block diagram illustrating an exemplary, non-limiting embodiment of an auto-reversion during comms failure following fault recovery in a fiber optic network functioning in accordance with various aspects described herein.

FIG. 1E is a block diagram illustrating an exemplary, non-limiting embodiment of a node upgrade following fault recovery in a fiber optic network functioning in accordance with various aspects described herein.

FIG. 2 is a block diagram illustrating an exemplary, non-limiting embodiment of a node upgrade with a capacity change mode upgrade following fault recovery in a fiber optic network functioning in accordance with various aspects described herein.

FIG. 3A depicts an illustrative embodiment of a method of a periodic protect route audit in accordance with various aspects described herein.

FIG. 3B depicts an illustrative embodiment of a method triggered during an automatic or manual operation in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

### DETAILED DESCRIPTION

The subject disclosure describes, among other things, illustrative embodiments for a method and system for a health audit on a current working route in layer zero control plane (L0CP) networks. Other embodiments are described in the subject disclosure.

One or more aspects of the subject disclosure include a node in a fiber optic network, the node comprising a processing system comprising a processor and executable instructions that, when executed by the processing system, facilitate performance of operations, including receiving an automatic or manual trigger; checking nodes in a current working route for a failure responsive to receiving the automatic or manual trigger; raising an alarm responsive to detecting the failure; and performing operations associated with the automatic or manual trigger responsive to not detecting the failure.

One or more aspects of the subject disclosure include a non-transitory machine-readable medium, with executable instructions that, when executed by a processing system including a processor, facilitate performance of operations, including: checking nodes in a current working route of a fiber optic network for a failure responsive to detecting an automatic or manual trigger; raising an alarm responsive to detecting the failure; and performing operations associated with the automatic or manual trigger responsive to not detecting the failure.

One or more aspects of the subject disclosure include a method of checking, by a processing system including a processor, nodes in a current working route of a fiber optic network for a failure responsive to receiving an automatic or manual trigger; raising an alarm, by the processing system, responsive to detecting the failure; and performing operations associated with the automatic or manual trigger, by the processing system, responsive to not detecting the failure.

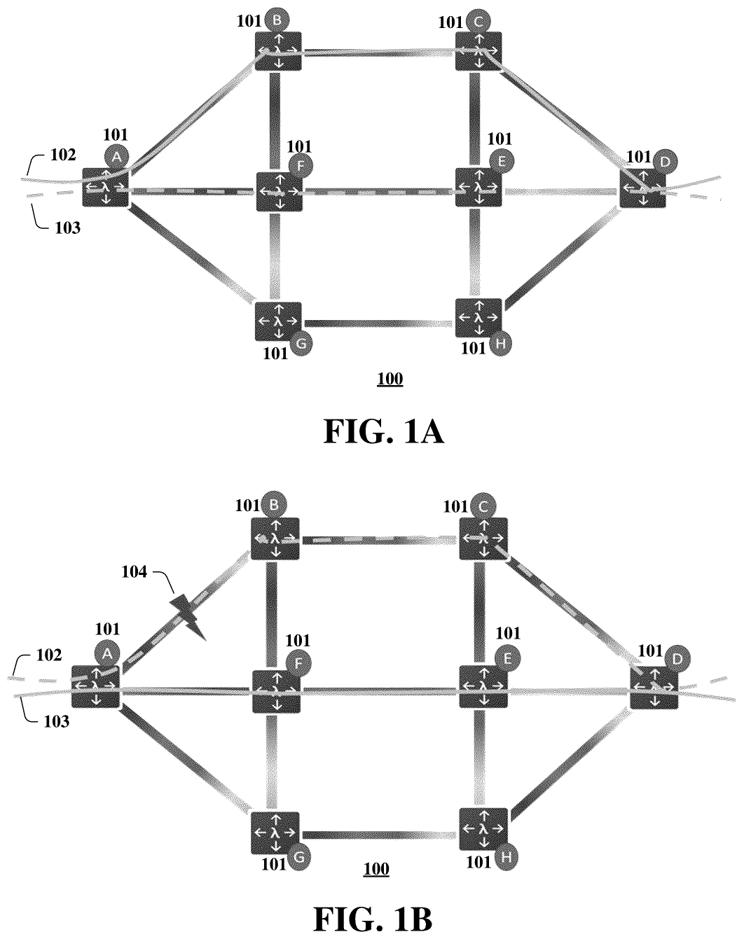

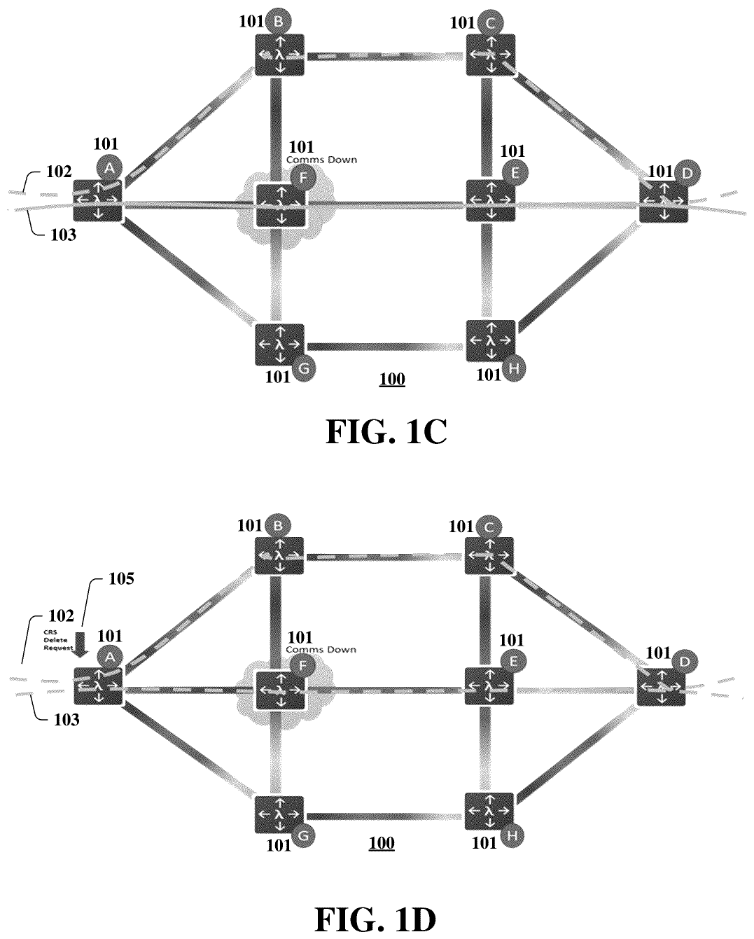

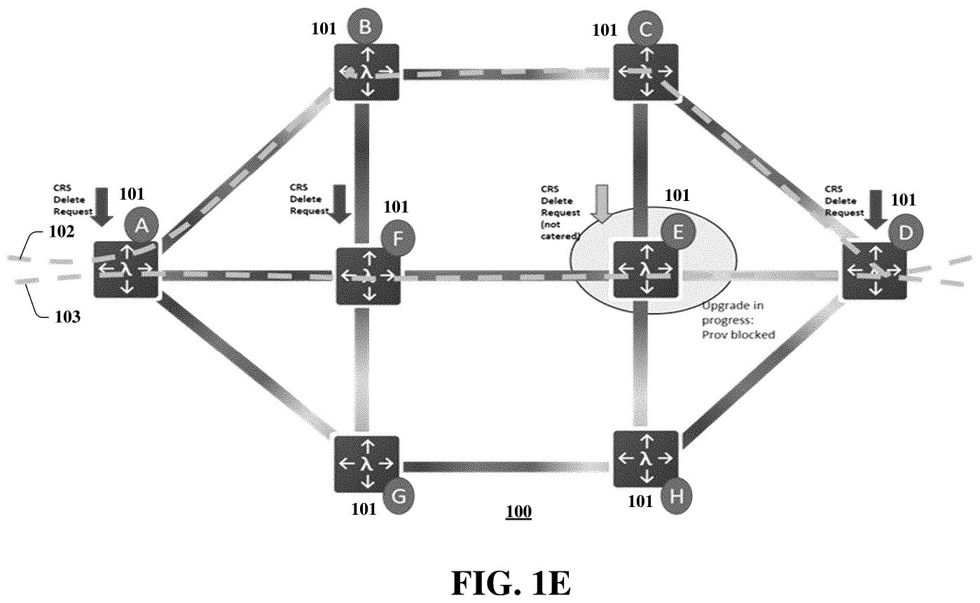

FIG. 1A is a block diagram illustrating an exemplary, non-limiting embodiment of a fiber optic network functioning in accordance with various aspects described herein. Referring to FIG. 1A, in one or more embodiments, network 100 comprises a series of cross connect (CRS) nodes 101. A service, illustrated by the solid yellow line, is running on a current working route between nodes 101A and 101D. A home designated transit list (DTL 102) is 101A-101B-101C-101D, which corresponds to the current working route. A protect route, DTL 103 is 101A-101F-101E-101D, which is illustrated by the dashed yellow line in FIG. 1A. There are two mechanisms of defining protect routes—a first one is explicit route where user select restoration routes along with home route, while a second, implicit method includes the user defining the home path and the control plane will compute restoration routes. No resources are reserved on the protect route, until and unless a switch is triggered.

FIG. 1B is a block diagram illustrating an exemplary, non-limiting embodiment of a fault in a fiber optic network functioning in accordance with various aspects described herein. Referring to FIG. 1B, in one or more embodiments, a fiber failure (fault 104) occurs on a link between nodes 101A-101B. Because of the fault 104, the service moves the current working route to the protect route DTL 103, now illustrated by a solid yellow line in FIG. 1B. As mentioned above, protect routes are provisioned either explicitly or implicitly. With explicit protect route provisioning, the user configures the Protect Routes in an order within the DTLSET, OSRP follows that particular order. In case of explicit routing, users have data from online or offline planning tools where link performance is predicted in advance.

Wherein no protect routes are configured or all the explicit protect routes become invalid, OSRP determines implicit protect routes by computation. The basis of such calculation is minimum cost within a maximum defined cost set by the user.

FIG. 1C is a block diagram illustrating an exemplary, non-limiting embodiment of a comms failure following fault recovery in a fiber optic network functioning in accordance with various aspects described herein. Referring to FIG. 1C, in one or more embodiments, the fault 104 illustrated in FIG. 1B recovers on the link between nodes 101A-101B on the home DTL 102, and thus is no longer present (or illustrated). When the fault 104 recovers, the L0CP starts the wait to revert (WTR) timer. The service waits for the WTR timer to expire before reverting the service over the home DTL 102, but before the WTR timer expires, communications for node 101F goes down, leading to a communications failure in the control path (i.e., comms failure) between 101A and 101F, as shown in FIG. 1C.

FIG. 1D is a block diagram illustrating an exemplary, non-limiting embodiment of an auto-reversion during comms failure following fault recovery in a fiber optic network functioning in accordance with various aspects described herein. As shown in FIG. 1D, the WTR timer expires and the service initiates an auto-reversion, which includes deprovisioning the CRS on the current working route, which is the protect DTL 103. Since comms went down between 101A and 101F, the control plane was only able to send a CRS Deletion Request 105 to 101A, but that request could not be sent on to the other sites. As a result, the CRS deletion on protect DTL 103 never succeeds, which leads to traffic going down and not being restored back to the home DTL 102.

FIG. 1E is a block diagram illustrating an exemplary, non-limiting embodiment of a node upgrade following fault recovery in a fiber optic network functioning in accordance with various aspects described herein. As shown in FIG. 1E, a sub network connection (SNC) running on protect DTL 103 has an upgrade in progress on node 101E. During upgrades, provisioning is blocked, which prevents CRS Deletion Request from being fulfilled on node 101E. Hence, traffic cannot be restored to home DTL 102 until the upgrade is completed, which may cause traffic to go down for hours.

There may be many other conditions which may bring the traffic down, create unexpected delays in restoring the traffic which may not be acceptable to the customer, such as manual operations (Lock, Manual Switch, Manual Revert and Regroom, etc.), where the user is allowed to perform a corresponding operation based on prospective future path without taking into consideration of current working route.

To avoid such problems, the system implements a new health check algorithm for the current working route. The algorithm verifies the end-to-end integrity of the current working route and ensures that the current working route is capable of handling a CRS Deletion Request. If the algorithm detects any issues, a new alarm “SNC E2E Control Path not UP,” will notify the user about the current working route status.

In an embodiment, the L0CP audits the current working route at fixed intervals to uncover any end-to-end issue. In an embodiment, the existing periodic protection route validation/computation audit may be used for this purpose. In case the current working route is not up, the L0CP raises a “SNC E2E Control Path not UP” alarm along with fault details in corresponding additional text. In an embodiment, this alarm can be cleared in case of following conditions:
If L0CP finds no issue on the current working route during next protection route audit;
If an originating node restarts; or
If a release event happens on a corresponding SNC.

The alarm can be useful to the user, since the alarm helps the user to understand the status of the current working route, which can help the user to make informed decisions before making any future decisions. In case of any manual or automatic triggers (other than faults), if L0CP discovers that the current working route is not in the position to deprovision the CRS along the working route, the L0CP may either deny the current operation or increase the capacity change mode, depending upon user preferences as set forth below.

In an embodiment, if the L0CP denies the current operation:
In case of auto-reversion, the L0CP will reinitiate the WTR timer and log the corresponding failure reason in the SNC/SNCG diagnostics. Further, L0CP will raise an alarm along with the corresponding failure reason in the additional text for presentation to the user.
In the case of manual operations, the L0CP will deny the manual operation and report the corresponding failure reason in error message to the user.

In an embodiment, if the L0CP increases the capacity change mode for CRS deletion request to MODE2. For MODE2, the deletion request underlying the local controller module does not wait for CRS deletion request to be present all along the route. In contrast, the CRS deletion operation in MODE1 sends the deletion request to all nodes along the SNC's current working route. Escalating the capacity change mode to MODE2 ensures successful automatic/manual operations, despite any issues present along the current working route. In an embodiment, the corresponding functionality works in the case that there are no upgrades/node-blocks and DOC-OOS on the originating or terminal nodes.

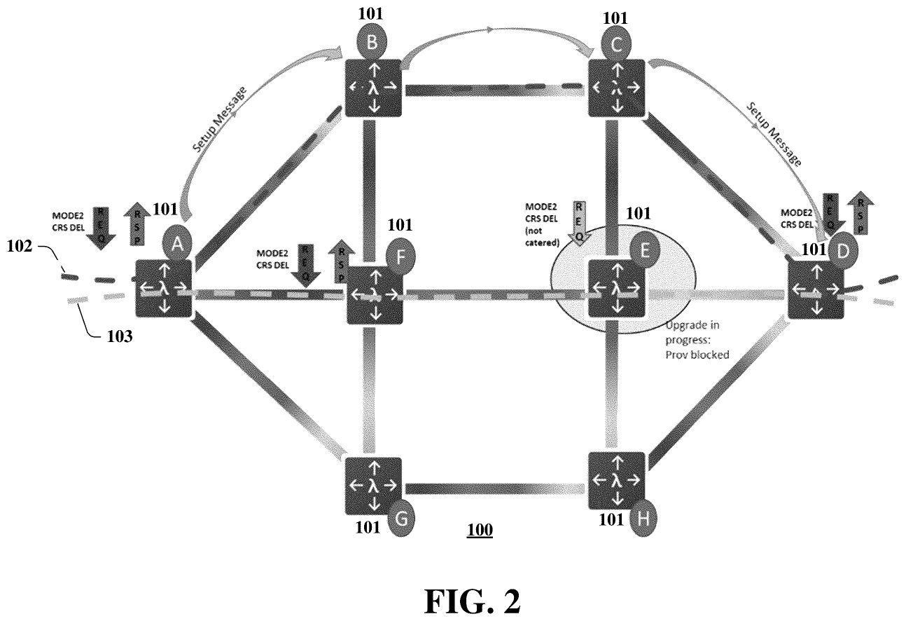

FIG. 2 is a block diagram illustrating an exemplary, non-limiting embodiment of a node upgrade with a capacity change mode upgrade following fault recovery in a fiber optic network functioning in accordance with various aspects described herein. With reference to FIG. 1E, a sub network connection (SNC) running on protect DTL 103 has an upgrade in progress on node 101E. During upgrades, provisioning is blocked, which prevents CRS Deletion Request from being fulfilled on 101E. Hence, traffic cannot normally be restored to home DTL 102 until the upgrade is completed.

However, there may be many conditions which can be handled by Capacity Change Mode Escalation. In the embodiment illustrated in FIG. 2, during SNC Auto Reversion, L0CP discovers that 101E is blocked due to upgrade in progress. L0CP increases the capacity change mode for the CRS Deletion request from MODEL to MODE2, which sends the CRS deletion request along home DTL 102 to nodes 101A, 101F, 101E and 101D. In MODE2, deletion of the underlying Control Module does not wait for the CRS Deletion request to arrive on all other nodes along the route. Instead, the node immediately deletes the corresponding Cross Connect and sends the response to L0CP (except at 101E, since provisioning is blocked due to the upgrade). Next, L0CP sets up a call on Home DTL 102. Subsequently, the upgrade completes on 101E, after which the corresponding Cross Connect gets deleted.

In an embodiment, a new parameter OPTIMIZATION_MODE for L0CP services is proposed. The following actions for the parameter can be configured:
NONE: The L0CP will not block the current operation and supports the legacy functionality;
DENY: denies the current operation and raises a “SNC E2E Control Path not UP” alarm; and
OPTIMIZE:
   a. Checks for a Provisioning Block, upgrades, or DOC-OOS is not on the originating/terminating node; and
   b. Escalates the Capacity Change Mode to MODE2 to forcefully complete the CRS Deletion operation.

In an embodiment, the proposed algorithm can be implemented at centralized fiber optic network management system (NMS), where a new license base application could be devised, that can monitor the current working route periodically. Depending on the current status, the algorithm will allow/disallow the corresponding manual operations. The proposed algorithm can also notify the user about current working route status through an informational message.

The “SNC E2E Control Path not UP” alarm provides an easy mechanism for the user to identify silent issues along the current working route of the SNC, which are otherwise difficult to recognize, since the user needs to scroll through all the nodes along the route to find corresponding issues. The technology ensures maximum traffic availability, in case of existing issues (other than fiber failures) on the current working route in case of automatic and manual operations. Further, the technology provides a facility for the user to forcefully perform automatic/manual operations, even in case any of the above-identified failures exist on the route, via capacity change mode escalations. However, when the OPTIMIZE setting is used, there may be a minor impact on channels running on a margin boundary, but this impact shall be momentary.

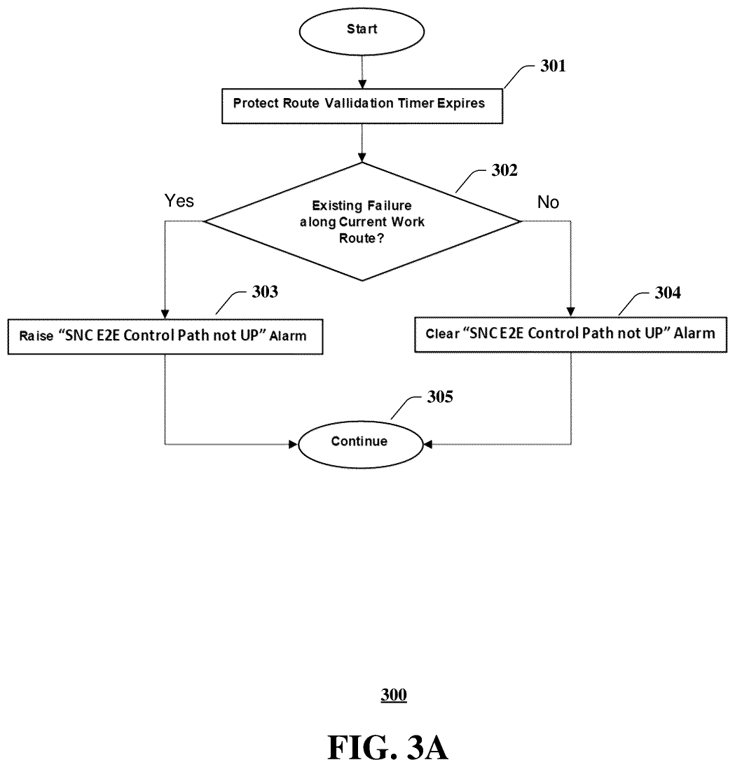

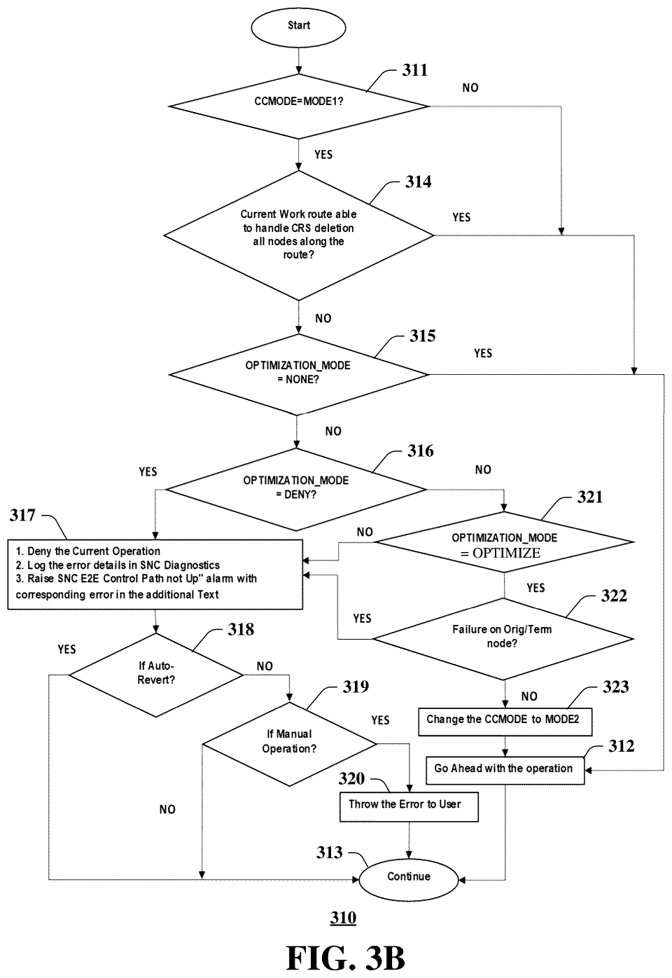

FIG. 3A depicts an illustrative embodiment of a method of a periodic protect route audit in accordance with various aspects described herein. As shown in FIG. 3A, method 300 begins with step 301 where a protect route validation timer expires. Next, in step 302, an L0CP performs a periodic protect route audit to check the status of current work route. The L0CP checks the current working route to see that there are no problems along the route, such as node blocks, upgrades in progress on any of the nodes in the route, comms failures, DOC-OOS, or other failures. In an embodiment, the periodic Protect Route audit can be performed every five minutes. If there is a problem, then the method proceeds to step 303, where the L0CP raises a “SNC E2E Control Path not UP” alarm, and the method continues at step 305. However, if there is no problem, then in step 304, the L0CP clears any “SNC E2E Control Path not UP” alarm and the process will continue at step 305.

FIG. 3B depicts an illustrative embodiment of a method triggered during an automatic or manual operation in accordance with various aspects described herein. As shown in FIG. 3B, method 310 begins with step 311 where the system checks the Capacity Change Mode (CCMODE). If the CCMODE is not MODE1, then the process continues at the next step 312.

In step 312, the system proceeds with the operation, and then the process continues at step 313. However, if in step 311 the CCMODE is MODE1, then the process proceeds to the next step 314 below.

In step 314, the system checks to see if a “SNC E2E Control Path not UP” alarm is present. Method 300 described above in connection with FIG. 3A would have identified this alarm. Namely, the system validates the current working route to check that there are no: node blocks along the route, upgrades in progress on any of the nodes, comms failures, DOC-OOS, local shelf sync issues, or some other failure.

If the alarm is not present, then the current working route is able to handle CRS deletion along all nodes on the route, so the process continues at step 312 above. However, if the alarm is present, then the current working route cannot handle the deletion, so the process continues to step 315.

In step 315, the system checks the OPTIMIZATION_MODE parameter. If the OPTIMIZATION_MODE parameter is set to NONE, then the process continues at step 312 above. If the OPTIMIZATION_MODE parameter is not set to NONE, the process continues at step 316.

In step 316, the system checks if OPTIMIZATION_MODE parameter is set to DENY. If the OPTIMIZATION_MODE parameter is not set to DENY, then the process continues at step 321 below. However, if the OPTIMIZATION_MODE parameter is set to DENY, then the process continues at step 317.

In step 317, the system denies the current operation, logs the error details in the SNC Diagnostics, and raises the “SNC E2E Control Path not UP” alarm with corresponding error in the additional text. The process continues at step 318.

In step 318, the system checks whether the trigger is a manual operation or an auto-reversion. If the trigger is not an auto-reversion, then the process continues at step 319. If the trigger is an auto-reversion, then the process continues at step 313.

In step 319, the system checks whether the trigger is a manual operation. If there is a manual operation, then the process continues at step 320 where the L0CP throws the error details to the operator and continues at step 313. If there is not a manual operation, then the process continues at step 313.

In step 321, the system checks whether the OPTIMIZATION_MODE is set to OPTIMIZE. If not, then the process proceeds per step 317 above. If so, then the process continues at step 322 where the system checks whether there is a failure detected on the originating or terminating node in the current working path. If the failure is on the originating/terminating node, the process proceeds per step 317. If the failure is elsewhere, the process proceeds to step 323, where the system escalates the CCMODE to MODE2 and proceeds with the operation per step 312 above.

While for purposes of simplicity of explanation, the respective processes are shown and described as a series of blocks in FIGS. 3A and 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Note, one or more blocks can be performed in response to one or more other blocks. Further, some portions of embodiments can be combined with portions of other embodiments.

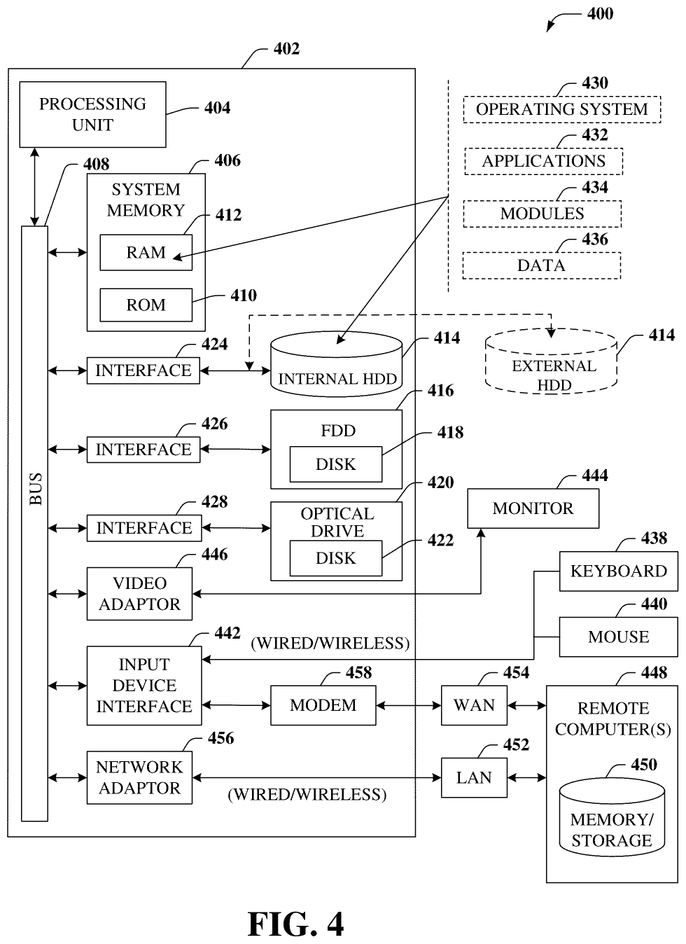

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, the computing environment 400 can be used in the computing device described herein. Each of these devices can be implemented via computer-executable instructions that can run on one or more computers, and/or in combination with other program modules and/or as a combination of hardware and software. For example, computing environment 400 can facilitate in whole or in part checking nodes in a current working route of a fiber optic network for a failure responsive to detecting an automatic or manual trigger; raising an alarm responsive to detecting the failure; and performing operations associated with the automatic or manual trigger responsive to not detecting the failure. Further, each of the server 100c, client computing device 100e, client computing device 100h, client computing device 200a, server 200b, client computing device 210a, and server 210b can comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. System memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen and the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. Modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

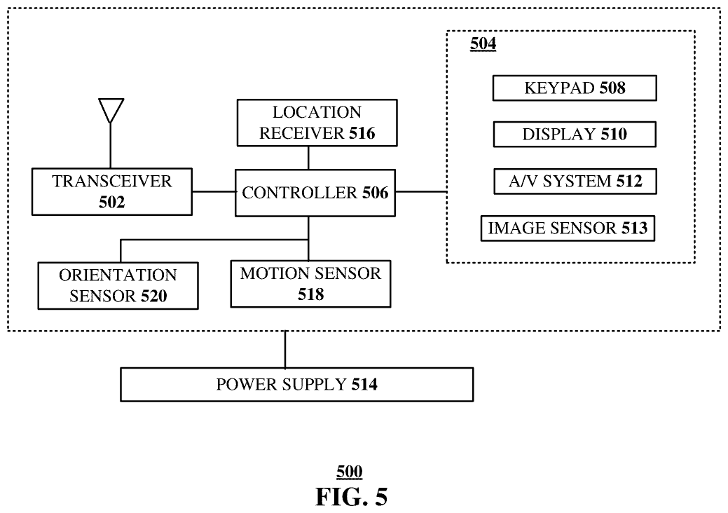

Turning now to FIG. 5, an illustrative embodiment of a communication device 500 is shown. Communication device 500 can facilitate in whole or in part checking nodes in a current working route of a fiber optic network for a failure responsive to detecting an automatic or manual trigger; raising an alarm responsive to detecting the failure; and performing operations associated with the automatic or manual trigger responsive to not detecting the failure. Further, each of the server 100c, client computing device 100e, client computing device 100h, client computing device 200a, server 200b, client computing device 210a, and server 210b can comprise communication device 500.

The communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VoIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface having graphical user interface (GUI) elements that can be selected by a user with a touch of a finger. Display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human ear) and high-volume audio (such as speakerphone for hands free operation). The audio system 512 can further include a microphone for receiving audible signals from an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable communications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and east, as well as combined orientations in degrees, minutes, or other suitable orientation metrics).

The communication device 500 can use the transceiver 502 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A node in a fiber optic network, the node comprising a processing system including a processor and executable instructions that, when executed by the processing system, facilitate performance of operations, the operations comprising:
receiving an automatic or manual trigger;
checking nodes in a current working route for a failure responsive to receiving the automatic or manual trigger; and
one of raising an alarm responsive to detecting the failure, and performing operations associated with the automatic or manual trigger responsive to not detecting the failure.

2. The node of claim 1, wherein the automatic or manual trigger comprises a protect route validation timer expiring or a wait to revert timer expiring.

3. The node of claim 1, wherein the failure comprises a node block, an upgrade in progress on any of the nodes in the current working route, a local shelf sync issues, a comms failure, a domain optical controller out of service, or any combination thereof.

4. The node of claim 1, wherein the operations further comprise:
checking a capacity change mode responsive to detecting the failure; and
performing the operations associated with the automatic or manual trigger responsive to the capacity change mode not set to MODE1.

5. The node of claim 4, wherein the operations further comprise:
checking an OPTIMIZATION_MODE parameter responsive to the capacity change mode set to MODE1; and
performing the operations associated with the automatic or manual trigger responsive to the OPTIMIZATION_MODE parameter set to NONE.

6. The node of claim 5, wherein the operations further comprise: denying the operations associated with the automatic or manual trigger, logging error details in sub network connection diagnostics, and raising the alarm responsive to the OPTIMIZATION_MODE parameter set to DENY.

7. The node of claim 6, wherein the operations further comprise: checking for the failure on an originating node or a terminating node on the current working route responsive to the OPTIMIZATION_MODE parameter set to OPTIMIZE; and denying the operations associated with the automatic or manual trigger, logging error details in sub network connection diagnostics, and raising the alarm responsive to the failure occurring on the originating node or the terminating node.

8. The node of claim 7, wherein the operations further comprise escalating the capacity change mode to MODE2 and performing the operations associated with the automatic or manual trigger responsive to the failure not occurring on the originating node or the terminating node.

9. The node of claim 8, wherein the operations associated with the automatic or manual trigger comprise a cross connect deletion request.

10. A non-transitory machine-readable medium, comprising executable instructions that, when executed by a processing system including a processor, facilitate performance of operations, the operations comprising:
checking nodes in a current working route of a fiber optic network for a failure responsive to detecting an automatic or manual trigger; and
one of raising an alarm responsive to detecting the failure, and performing operations associated with the automatic or manual trigger responsive to not detecting the failure.

11. The non-transitory machine-readable medium of claim 10, wherein the failure comprises a node block, an upgrade in progress on any of the nodes in the current working route, a local shelf sync issue, a comms failure, a domain optical controller out of service, or any combination thereof.

12. The non-transitory machine-readable medium of claim 10, wherein the operations further comprise:
checking a capacity change mode responsive to detecting the failure; and
performing the operations associated with the automatic or manual trigger responsive to the capacity change mode not set to MODE1.

13. The non-transitory machine-readable medium of claim 12, wherein the operations further comprise:
checking an OPTIMIZATION_MODE parameter responsive to the capacity change mode set to MODE1; and
performing the operations associated with the automatic or manual trigger responsive to the OPTIMIZATION_MODE parameter set to NONE.

14. The non-transitory machine-readable medium of claim 13, wherein the operations further comprise: denying the operations associated with the automatic or manual trigger, logging error details in sub network connection diagnostics, and raising the alarm responsive to the OPTIMIZATION_MODE set to DENY.

15. The non-transitory machine-readable medium of claim 14, wherein the operations further comprise: checking for the failure on an originating node or a terminating node on the current working route responsive to the OPTIMIZATION_MODE parameter set to OPTIMIZE; and denying the operations associated with the automatic or manual trigger, logging error details in sub network connection diagnostics, and raising the alarm responsive to the failure occurring on the originating node or the terminating node.

16. The non-transitory machine-readable medium of claim 15, wherein the operations further comprise escalating the capacity change mode to MODE2 and performing the operations associated with the automatic or manual trigger responsive to the failure not occurring on the originating node or the terminating node.

17. The non-transitory machine-readable medium of claim 16, wherein the operations associated with the automatic or manual trigger comprise a cross connect deletion request.

18. The non-transitory machine-readable medium of claim 17, wherein the automatic or manual trigger comprises a protect route validation timer expiring or a wait to revert timer expiring.

19. A method, comprising:
checking, by a processing system including a processor, nodes in a current working route of a fiber optic network for a failure responsive to receiving an automatic or manual trigger; and
one of raising an alarm, by the processing system, responsive to detecting the failure, and performing operations associated with the automatic or manual trigger, by the processing system, responsive to not detecting the failure.

20. The method of claim 19, further comprising:
checking, by the processing system, a capacity change mode responsive to detecting the failure;
performing, by the processing system, the operations associated with the automatic or manual trigger responsive to the capacity change mode not set to MODE1;
checking, by the processing system, an OPTIMIZATION_MODE parameter responsive to the capacity change mode set to MODE1;
performing, by the processing system, the operations associated with the automatic or manual trigger responsive to the OPTIMIZATION_MODE parameter set to NONE;
denying, by the processing system, the operations associated with the automatic or manual trigger, logging error details in sub network connection diagnostics, and raising the alarm responsive to the OPTIMIZATION_MODE parameter set to DENY;
checking, by the processing system, for the failure on an originating node or a terminating node on the current working route responsive to the OPTIMIZATION_MODE parameter set to OPTIMIZE;
denying, by the processing system, the operations associated with the automatic or manual trigger, logging error details in sub network connection diagnostics, and raising the alarm responsive to the failure occurring on the originating node or the terminating node; and
escalating, by the processing system, the capacity change mode to MODE2 and performing the operations associated with the automatic or manual trigger responsive to the failure not occurring on the originating node or the terminating node.
